(19) United States
(12) Patent Application Publication
(10) Pub. No.: US 2015/0196459 A1
(43) Pub. Date: Jul. 16, 2015

(54) Pill Counting and Conveying Apparatus

(71) Applicant: Pearson Medical Technologies, L.L.C., Alexandria, LA (US)

(72) Inventors: W. Brent Pearson, Alexandria, LA (US); Yesudasan Sujith, Alexandria, LA (US)

(73) Assignee: Pearson Medical Technologies, L.L.C., Alexandria, LA (US)

(21) Appl. No.: 14/094,384

(22) Filed: Dec. 2, 2013

(51) Int. Cl. A61J 7/02

(52) U.S. Cl. CPC A61J 7/02

(57) ABSTRACT

A pill conveying apparatus including a housing with a pill discharge aperture. A vacuum drum positioned at least partially within the housing, and the vacuum drum includes (i) a drum face having a primary surface; (ii) a plurality of pill apertures formed in the drum face, and (iii) at least one secondary surface formed on the drum face, the secondary surface varying in elevation relative to the primary surface. A vacuum source draws a vacuum through the pill apertures in the vacuum drum and a torque source is operatively connected to the vacuum drum in order to rotate the vacuum drum. A pill shelf positioned adjacent to the drum face and a pill removal arm inhibits multiple pills from being retained on a pill aperture by the vacuum source. A pill sensor is positioned on the apparatus to detect pills which will exit the discharge aperture.

### BACKGROUND OF INVENTION

The present invention relates to pill or tablet (or other objects of approximately the same size) counting machines. In particular, the present invention relates to counting machines which handle and dispense the pills or tablets by use of a vacuum source. One such machine is seen in U.S. Pat. No. 6,997,341 which is incorporated by reference herein in its entirety. Nevertheless, improvements in these counting machines can increase their efficiency and reliability.

### BRIEF SUMMARY OF SELECTED EMBODIMENTS

One embodiment of the present invention is a pill conveying apparatus including a housing with pill discharge apertures. A vacuum drum positioned at least partially within the housing, and the vacuum drum includes (i) a drum face having a primary surface; (ii) a plurality of pill apertures formed in the drum face, and (iii) at least one secondary surface formed on the drum face, the secondary surface varying in elevation relative to the primary surface. A vacuum source draws a vacuum through the pill apertures in the vacuum drum and a torque source is operatively connected to the vacuum drum in order to rotate the vacuum drum. A pill shelf positioned adjacent to the drum face and a pill removal arm inhibits multiple pills from being retained on a pill aperture by the vacuum source. A pill sensor is positioned on the apparatus to detect pills which will exit the discharge aperture.

Another embodiment is a pill conveying apparatus including a housing with pill discharge apertures. A vacuum drum positioned at least partially within the housing and an upper end of the drum face is tilted at least 10° from a gravitational vertical in a direction away from a pill shelf. A vacuum source draws a vacuum through the pill apertures in the vacuum drum and a torque source is operatively connected to the vacuum drum in order to rotate the vacuum drum. The pill shelf positioned adjacent to the drum face and a pill removal arm inhibits multiple pills from being retained on a pill aperture by the vacuum source. A pill sensor is positioned on the apparatus to detect pills which will exit the discharge aperture.

Still further embodiments are described in the present application and the scope of invention is not limited to any particular embodiments described herein.

### BRIEF DESCRIPTION OF DRAWING

FIG. 1 illustrates a perspective view of the outer housing of one embodiment of the invention.

FIG. 2 illustrates an exploded view of one embodiment of the invention.

FIG. 3 illustrates the reverse of the exploded view seen in FIG. 2.

FIG. 4 illustrates an assembled side cross-section of the FIG. 2 embodiment.

FIG. 5 illustrates an assembled frontal cross-section of the FIG. 2 embodiment.

FIGS. 6A and 6B illustrate one drum face embodiment of the present invention.

FIGS. 7A and 7B illustrate another drum face embodiment of the present invention.

FIG. 8 illustrates an electronic component diagram of one embodiment.

FIG. 9 illustrates one embodiment of programming logic for operating the disclosed apparatus.

### DETAILED DESCRIPTION OF SELECTED EMBODIMENTS

In the drawings, many details pertaining to fabrication of the invention are well-established in the machine construction arts and are not material to the points of novelty, are omitted in the interest of descriptive clarity and efficiency. Additionally, the term “pill” as used herein can mean any form of pill, tablet, or capsule related to medication, vitamins, or dietary supplements. Moreover, any approximately pill sized article, regardless of whether the article is related to medications, vitamins, or dietary supplements, is intended to come within the definition of the term “pill” as used in the present disclosure.

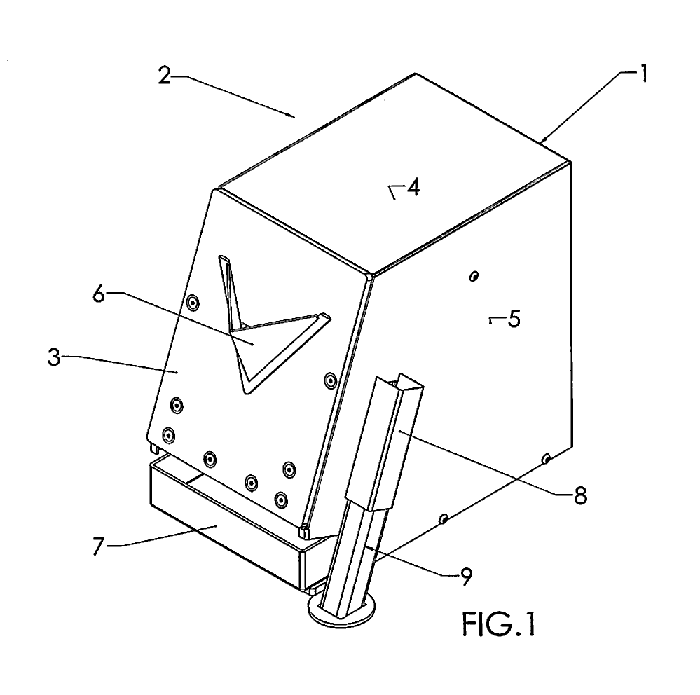

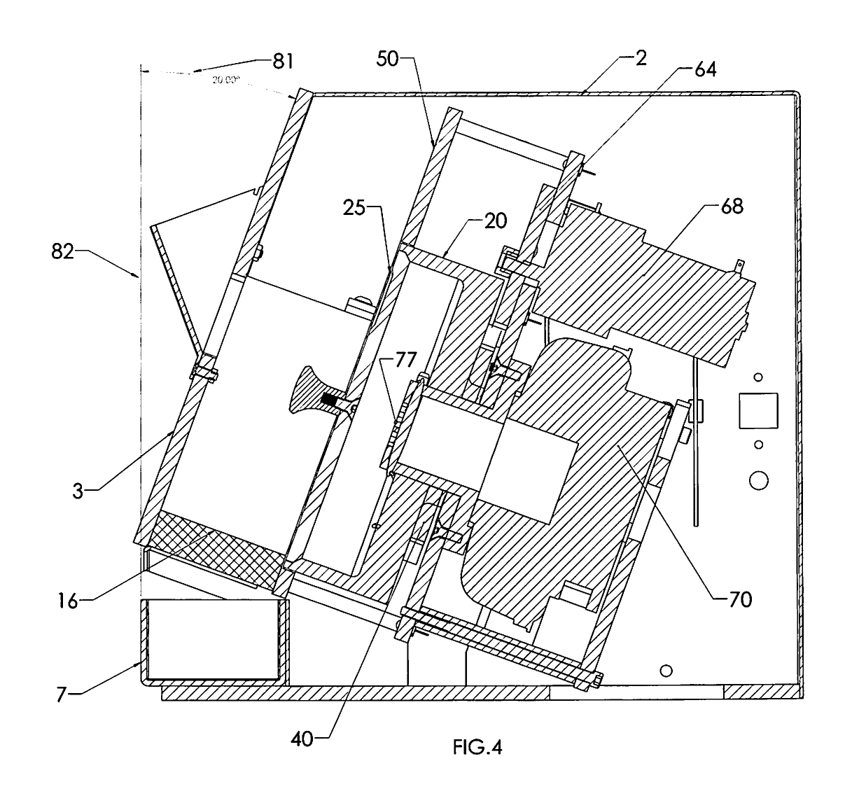

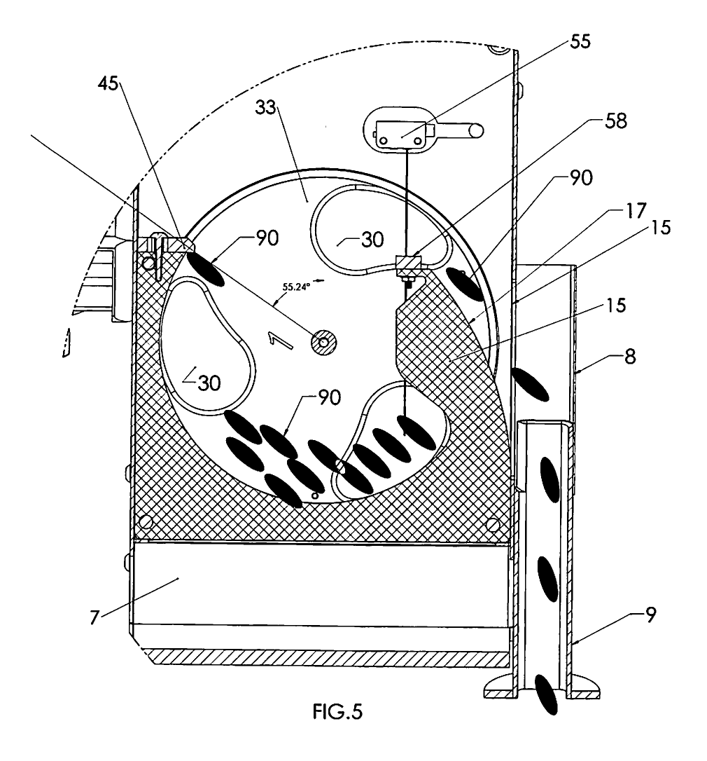

One embodiment of the present invention is a pill conveying apparatus such as seen in FIGS. 1 to 9. As suggested in FIG. 1, this embodiment includes the (outer) housing 2 formed of front plate 3, side plates 5, and top plate 4. Housing 2 may be formed of any suitable material, including a hard plastic or a metal. Front plate 3 has the pill feed chute 6 into which pills are placed and enter the interior of housing 2 though the feed aperture 11 (seen in FIG. 4). Although hidden from view in FIG. 1 by guide channel 8, a pill discharge aperture is formed through side plate 5 (see aperture 11 in FIG. 5) such that pills exiting housing 2 through this aperture will be directed by guide channel 8 downward into exit chute 9. Although guide channel 8 and exit chute 9 may be made of any suitably rigid material, in a preferred embodiment, exit chute 9 is made of a transparent acrylic. Although not illustrated, it will be understood that in many embodiments (but not all), some type of pill package will be positioned below exit chute 9 to receive the exiting pills. The packages might be manually removed and replaced as filled, or an automated packaging machine might advance successive packages beneath the bottom opening of exit chute 9.

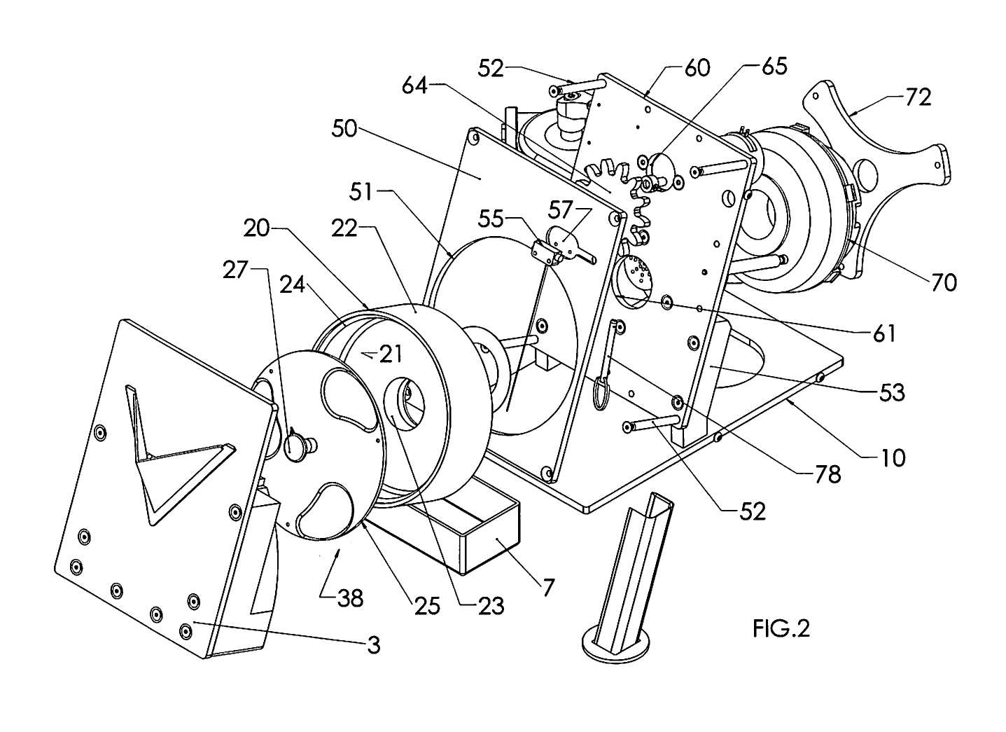

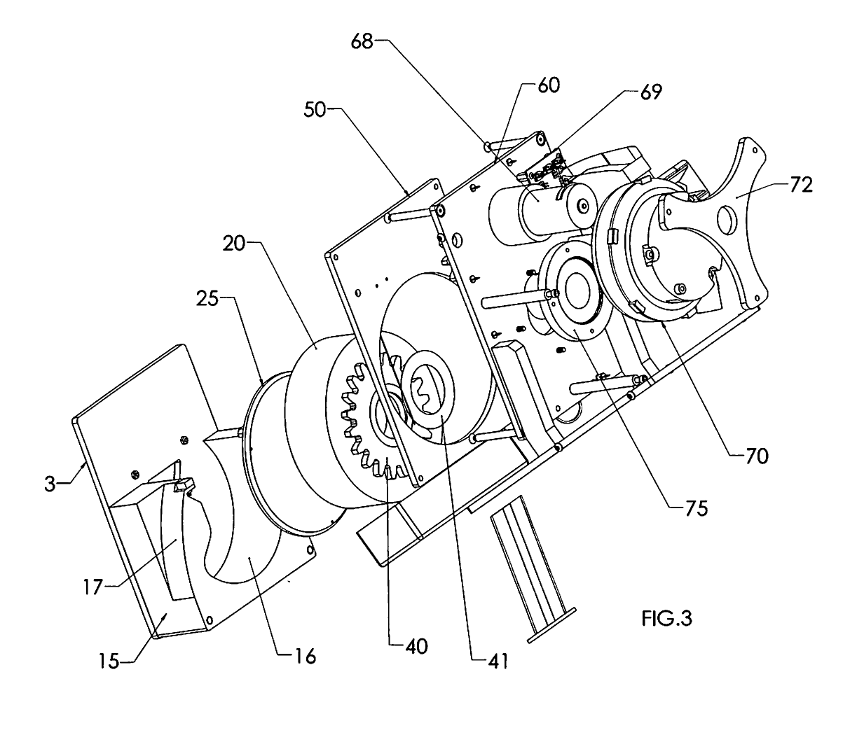

FIG. 2 illustrates many of the pill conveying apparatus' components internal to housing 2. Certain of the main components include vacuum drum 20, drum plate 50, main plate 60, vacuum source 70, and torque source or motor 68 (seen in FIG. 3). The illustrated embodiment of vacuum drum 20 further includes a drum body formed of drum back wall 21 with rear aperture 23 surrounded by the circumferential drum sidewall 22. The front of vacuum drum 20 is formed by drum face 25. FIG. 2 also shows how the illustrated embodiment further includes an internal circumferential shoulder 24. These components of vacuum drum 20 may be formed of any suitable material, but in one preferred embodiment are constructed of an acetal plastic such as Delrin®, available from DuPont de Nemours & Co. In the embodiment of FIG. 2, drum face 25 is a plate member separable from a remainder of the vacuum drum 20 and rests against internal drum shoulder 24 when assembled with the vacuum drum body. It will be understood that in certain embodiments, a plurality of plate member drum faces, wherein each plate member drum face has pill apertures of a different diameter, may be employed to accommodate different sizes and shapes of pills. The FIG. 2 embodiment shows a hand knob 27 on the drum face to facilitate easy substitution of one drum face for another.

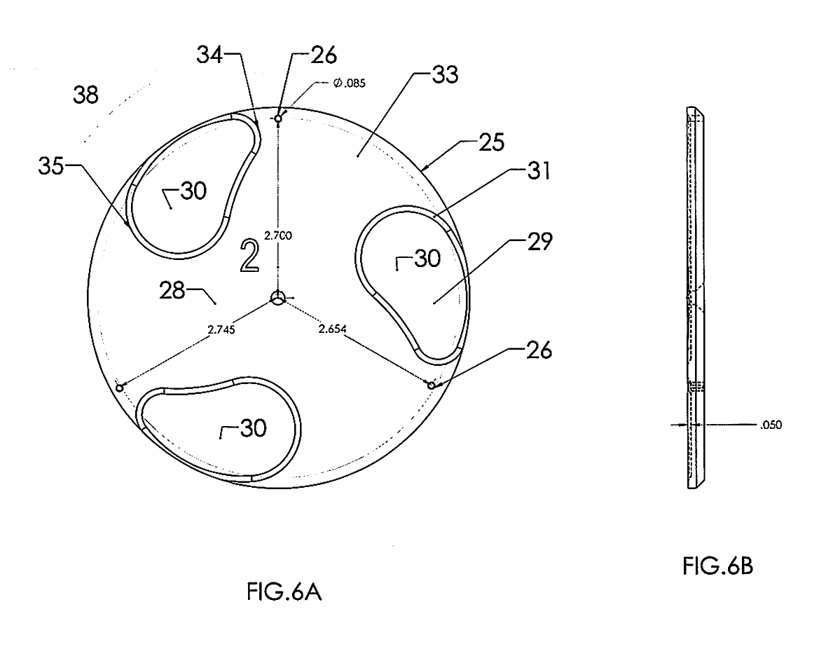

FIGS. 6A and 6B show several features of drum face 25 in greater detail. In FIG. 6A, drum face 25 includes a primary surface 28 and at least one (three in FIG. 6A) secondary surfaces 29. In the FIG. 6A embodiment, the primary surface 28 of the drum face 25 is the main surface area of the drum face and is substantially flat or planar. However, there may be embodiments where the primary surface 28 has some degree of curvature or does not have a uniform surface. The primary surface 28 will include at least one, or more generally, a plurality of pill apertures 26. The pill apertures 26 are openings in the drum face through which the vacuum force will operate as explained in more detail below. The figures illustrate three pill apertures 26, but other embodiments could utilize a different number, for example any number of pill apertures between one and fifteen (or even more pill apertures in specialized situations). Similarly, while preferred examples of pill apertures diameters may range between about 0.085 inches and 0.20 inches, other examples of aperture diameter may vary considerably from this range. Normally all of the pill apertures may have the same diameter, but specialized embodiments may include pill apertures of different diameters.

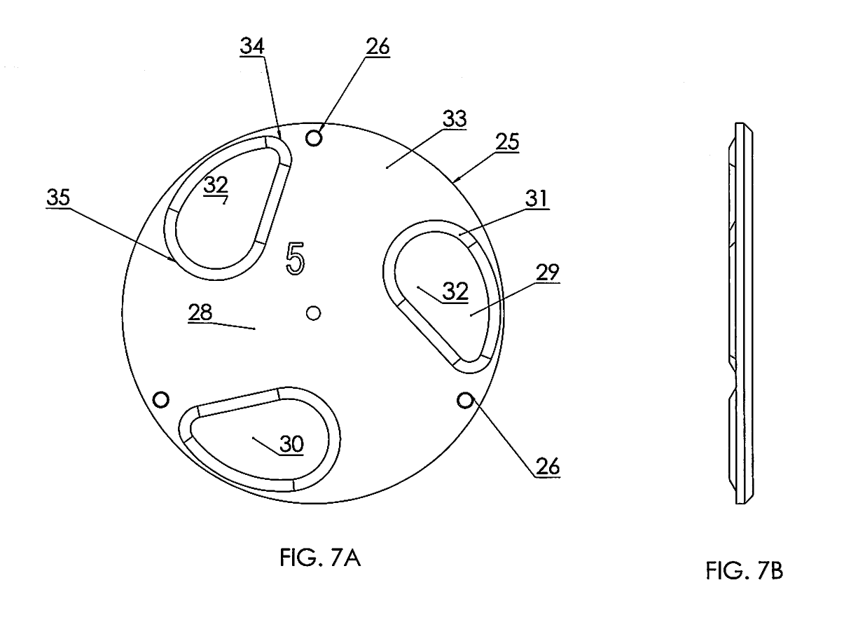

In different embodiments, the positioning of the pill apertures 26 can vary based of several factors, including pill size, pill shape, pill weight, and pill surface (e.g., smooth, coated, or powdery). In the embodiments of FIGS. 6A and 7A, the center of the pill apertures are positioned at least one-half of the aperture diameter away from a perimeter edged of the drum face. In another embodiment, the center of the pill apertures are positioned at least a full aperture diameter away from the perimeter edge of the drum face. However, many other aperture positions are within the scope of the invention, including where one pill aperture is a first distance from the perimeter and a second pill aperture is a second, different distance from the perimeter (as shown in FIG. 6A). The secondary surfaces 29 are distinguishable from the primary surface 28 in that the secondary surfaces vary in elevation from the primary surface. In the embodiment of FIGS. 6A and 6B, secondary surface 29 is formed by a depression 30 in primary surface 28. However, in an alternate embodiment, seen in FIGS. 7A and 7B, secondary surface 29 is formed by a raised section or “mound” 32 on primary surface 28. FIGS. 6 and 7 also illustrate alternate embodiments to be used in conjunction with different pill sizes (FIG. 6 showing smaller pill apertures 26 for smaller pills and FIG. 7 showing larger pill apertures 26 for larger pills). In the illustrated embodiments, the depth of the depressions 30 (or heights in the case of mounds) range between about 0.05 and 0.10 inches in depth, but other embodiments not illustrated could have depths outside this range. In FIGS. 6 and 7, the secondary surfaces 29 are positioned along a perimeter area 33 of drum face 35, the “perimeter area” being the portion of the drum face more proximate the perimeter than the center of the drum face. Indeed, the embodiments of FIGS. 6A and 7A illustrate the secondary surfaces 29 (depressions) are predominantly positioned in the perimeter area. Secondary surfaces 29 will also include transition edges 31 where the primary surface 28 slopes into the secondary surfaces 29.

It may be seen in FIGS. 6A and 7A how in preferred embodiments of secondary surfaces 29, there exists a more narrow leading portion 34 and a wider trailing portion 35. “Narrow” and “wide” are used in the sense of being relative to the distance of the secondary surface extending radially between the center of the drum face and the perimeter edge of the drum face. In the illustrated embodiments, the narrow portion 34 is “leading” in the sense that this portion of secondary surface 29 is more proximate to the pill apertures 26 relative to the primary rotational direction of the vacuum drum. The “primary rotational direction” of the vacuum drum (directional arrow 38 in FIG. 6A) may be defined as the direction the drum rotates to pick up a pill and dispense it out of the discharge aperture of the pill counter. FIG. 5 suggests how the primary rotational direction is clockwise in the illustrated embodiment.

Further components of the illustrated embodiment of the pill conveying apparatus are better seen in FIGS. 2 and 3. FIG. 3 shows how this embodiment will have attached to the rear side of front plate 3 a pill shelf assembly 15, which includes pill exit ramp 17 and pill shelf area 16. FIGS. 4 and 5 suggest how this allows drum face 25 to be positioned against pill shelf 16 and how pills on pill shelf 16 will tend to rest against drum face 25. FIG. 2 shows drum plate 50 with drum aperture 51 for accommodating vacuum drum 20 and a mounting cavity 57 to accept pill sensor 55. In certain embodiments, pill sensor 55 is a photo-electric pill sensor, i.e., a sensor which operates by emitting a light source and detecting the pill passing through that light source, for example a reflective laser such as the Retro Reflectiv Laser Sensor Model Q12RB6LP manufactured by Banner Engineering Corporation, 9714 Tenth Avenue North, Minneapolis, Minn. 55441. However, pill sensor 55 could alternatively operate on various other optical or non-optical detection mechanisms Such as a vision sensor, motion sensor or inductive sensor. Drum plate 50 will be secured to the main plate 60 by bolts 52 and main plate 60 is in turn secured to base plate 10 by support legs 53. Main plate 60 is also shown as having a vacuum aperture 61 and a motor aperture 65. The drive gear 64 (seen detached from motor 68) is also shown in FIG. 2. FIG. 3 illustrates how this embodiment of vacuum drum 20 includes the drum gear 40 formed on the back of the vacuum drum, a stainless steel washer 41, the vacuum hub 75, motor 68, break-out board 69, vacuum source 79, and vacuum mounting bracket 72. In one embodiment, vacuum source 79 is a brushless blower Model No. 119379-52 available from AMETEK, Inc., 1100 Cassatt Road, P.O. Box 1764, Berwyn, Pa. 19312 USA. The cross-section view of FIG. 4 perhaps best shows these components in their assembled state. The narrower diameter section of vacuum hub 75 extends through vacuum aperture 61 into the vacuum drum 20 and the wider diameter portion of the vacuum hub is fixed to main plate 60. The end of the narrower diameter portion of vacuum hub 75 illustrates a plurality of apertures 77 which allow air to be pulled from the interior vacuum drum 20 through hub 75. The narrower diameter of the vacuum hub 75 forms the axis upon which the vacuum drum 20 rotates. FIG. 4 suggests how pin 78 extends through the end of vacuum hub 75 to maintain the hub and pill drum in the relative positions shown. In this embodiment, the vacuum source (i.e., blower) is mounted directly behind the vacuum drum (e.g., on the vacuum hub 75 engaging the vacuum drum 20). It will be apparent that the vacuum generated by vacuum source 70 will create a vacuum in the interior area of vacuum drum 20 and ultimately pull a vacuum through the pill apertures 26. The drive shaft of drive motor 68 will extend through motor aperture 65 in main plate 60 and engage drive gear 64, which in turn engages drum gear 40. In one example, drive motor 68 is a variable speed motor such as a motor Model No. GM9213-3 manufactured by Ametek Pittman, Inc., 343 Godshall Drive, Harleysville, Pa. 1943. Break-out board 69 is circuitry associated with the operation of pill sensor 55.

FIG. 4 also illustrates how in this embodiment of drum face 25 is tilted rearward (i.e., away from the pill shelf) a given degree. In this example, the support legs 53 (see FIG. 2) support main plate 60 in this tilted orientation and drum plate 50 and vacuum drum 20 are fixed parallel to main plate 60. In FIG. 4, drum face 25 is tilted about 20° from the gravitational vertical 82 (i.e., the downward direction relative to gravitational force). However, other embodiments may be tilted between about 15° and 40°, or in still other embodiments between about 10° and 70° from the gravitational vertical.

FIG. 5 illustrates other components of the apparatus and suggests how the pills 90 are conveyed through the counting apparatus. FIG. 5 shows how the clockwise rotating vacuum drum will carry pills adhering to the pill apertures 26 (due to the vacuum pulled through these apertures) to the exit ramp 17 where pills will be dislodged from pill apertures 26 by the exit ramp and continue down guide channel 8 and exit chute 9. FIG. 5 also shows a reflecting surface 58 near the top of exit ramp 17 and under pill sensor 55. When pill senor 55 is of the optical type (e.g. a reflective laser), reflecting surface 58 will assist in pill sensor 55 detecting the passage of pills. In this embodiment, reflecting surface 58 is formed by a reflective mirror such as reflector Model No. BRT-11X11MD, manufactured by Banner Engineering Corporation, 9714 Tenth Avenue North, Minneapolis, Minn. 55441.

FIG. 5 also illustrates a pill removal arm 45, which will act to inhibit more than a single pill from being carried on each pill aperture. In the embodiment of FIG. 5, the pill removal arm is positioned such that (i) the pill removal arm extends no further than half-way across a diameter of the pill apertures as the pill apertures pass the pill removal arm; and (ii) the pill removal arm is positioned no further away from the edge of the pill aperture than one-half the diameter of the pill aperture. Of course, in other embodiments, the pill apertures may be spaced at different distances from the perimeter. FIG. 5 best illustrates the position of the pill removal arm 45 in embodiment of the various figures. The perimeter of vacuum drum 20 may be considered as defining an arc of vacuum drum rotation. It may be see that the FIG. 5 embodiment positions pill removal arm 45 on the side of housing 2 which is opposite the housing side having exit ramp 17. More specifically, when the pill shelf has a maximum fill level, the pill removal arm is generally positioned above the maximum fill level. Alternatively, the pill removal arm may be positioned between an angle α of about 0° and about 120° from a gravitational vertical in a direction opposite a primary rotational direction (i.e., the counter-clockwise direction in FIG. 5). Still more preferably, the pill removal arm is positioned between about 45° and about 90° from the gravitational vertical. Again, other non-illustrated embodiments may position the pill removal arm differently from the above description.

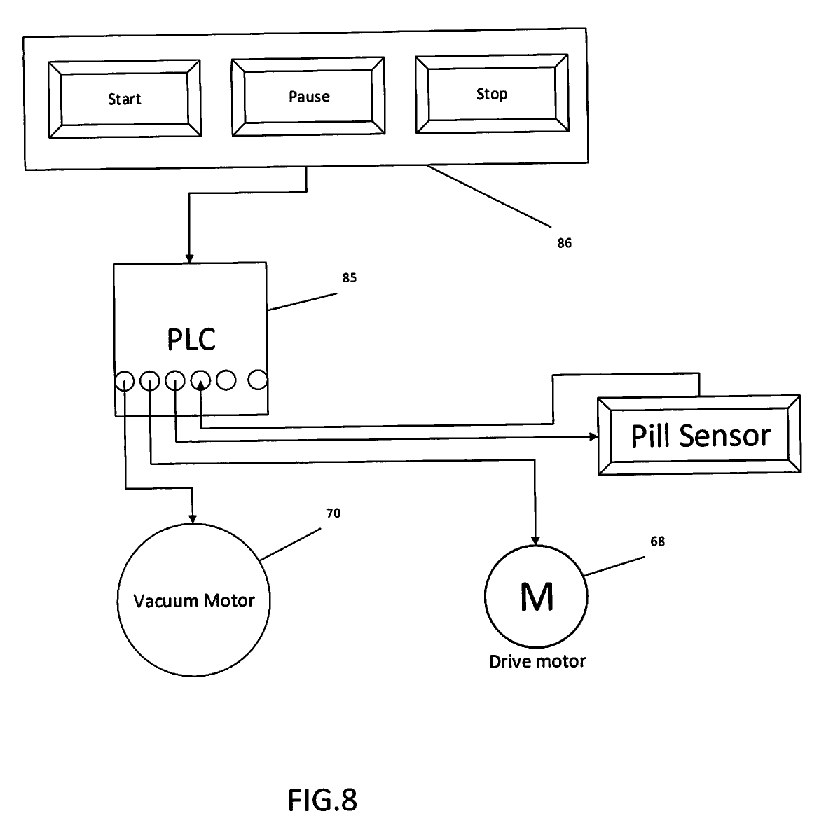

FIG. 8 shows one example of the electronic control components which could be used in the illustrated embodiment of the pill counter. The programmable logic controller 85 may receive inputs from various sources such as manual control inputs 86 (e.g., start, pause, stop). Although not explicitly shown, it will be understood that PLC 85 may receive programming input from a conventional PC and much of the apparatus' operation may also be initiated by the PC. Alternatively (but not illustrated), a numeric or alpha-numeric keypad could be associated with the apparatus, allowing entry of initial data and start of the counting process via the keypad. FIG. 8 suggests how output signals from the PLC may be directed to the vacuum source 70, drive motor 68, and pill sensor 55. One or more of these components (particularly pill sensor 55) may send signals to the input side of PLC 85. Obviously, power lines would exist to supply power to the various components, but these have been omitted for clarity.

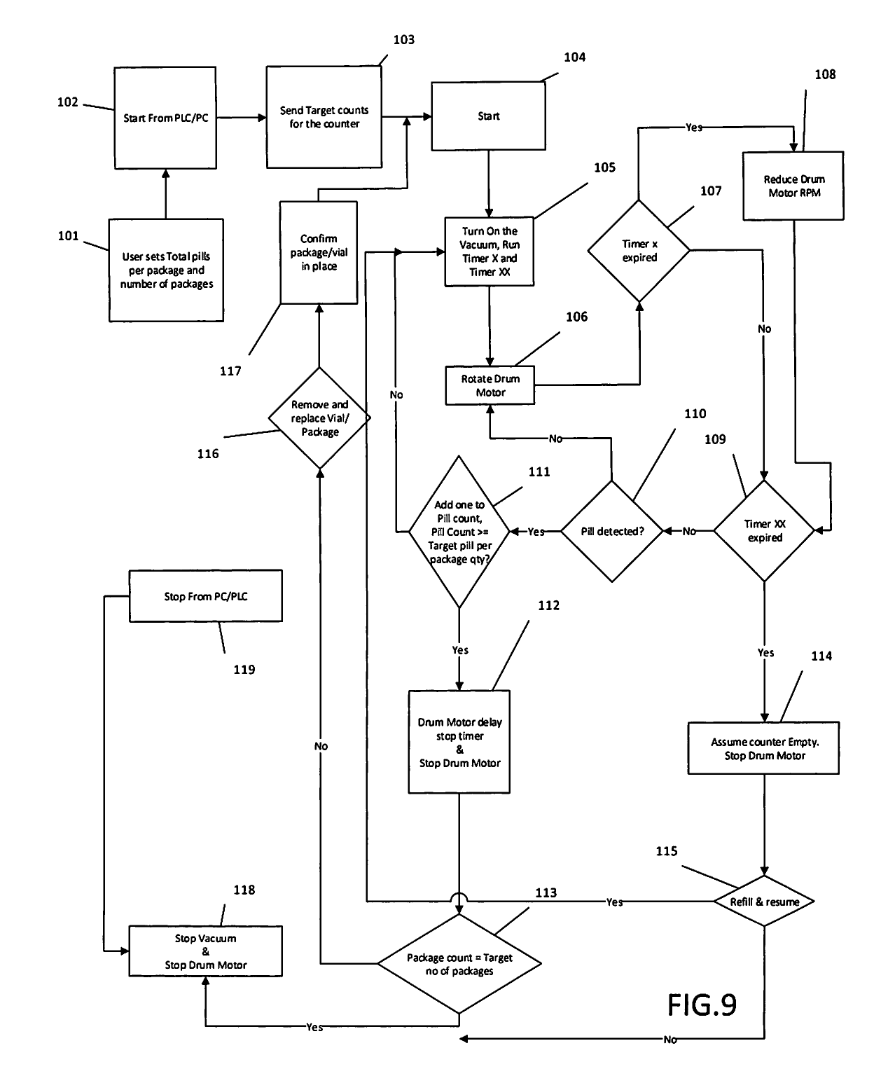

The flow chart of FIG. 9 illustrates one example of programming logic which could be employed in conjunction with PLC 85. In step 101, the user inputs the number of pills to be counted into each package (“pills per package”) and the total number of packages (“package number”) expected to be filled in a particular session using the counting apparatus. The initial data may be entered any number of ways, for example through a PC communicating with the PLC or through a numeric keypad (not illustrated) directly providing inputs to the PLC. In step 102, the program is initiated (again either through a PC or as a direct keypad input). In step 103, the pills per package quantity and the package numbers are sent to the memory of the PLC and the start step 104 initiates a counting loop. The initial step 105 in this loop sets two timer variables, an initial period “X” and a second, longer period “XX”. In this example, Time X may represent the longest time it is anticipate a properly functioning apparatus would take to pick up a pill from the pill shelf and move it to the exit ramp where the pill sensor will detect the pill. The failure of the pill sensor to detect a pill within period “X” would suggest that the number of pills in the pill shelf is low, necessitating the rotation of the vacuum drum 20 to be slowed down in order to allow the vacuum to pull to a loose pill toward a pill aperture Time XX may represent a time greater than Time X, the expiration of which without detecting a pill, would suggest that the pill shelf is empty. Step 106 energizes the drum motor and initiates rotation of the vacuum drum. The clock for Time X was initiated in step 105 and step 107 checks whether this time has expired. If Time X has expired, step 108 reduces the speed of the drive motor, which slows the rotational speed of the vacuum drum 20 as referenced above. The system then checks whether Time XX has expired in step 109. If yes, then the system presumes the pill shelf is empty and stops the drive motor in step 114 and, and in step 115, the system pauses for reloading of pills to the pill shelf followed by a restart command from the user (or for a stop command from the user). If no, the system proceeds to step 110 to check whether a pill has been detected.

Alternatively, if in step 107 the Time X has not expired (and Time XX has not expired in step 109), then a determination is made in step 110 as to whether a pill has been detected. If yes, then the system moves to step 111. If no, the system continues the loop of steps 106, 107, 108, and 109. In step 111, the system adds one to a “Pill Count” and determines whether the Pill Count equals the pills per package number. If no, the system returns to step 105 where Time X and Time XX are each reset and the drum continues the loop of steps 105 to 111.

If the decision in step 111 is yes, then step 112 initiates the drum motor stop after a brief delay to allow the last detected pill for the given package to be scraped off by the exit ramp and drop into the package. Step 113 determines whether the number of times the system has reached step 113 (the number of packages filled) equals the package number. If yes, step 118 shuts down the vacuum motor. Likewise, if a user enters a stop command from step 119, the system shuts down the vacuum motor and the drum motor. If step 113 returns no, then the system in step 116 instructs the user to remove the filled pill package and to confirm in step 117 that a new pill package has been installed to receive a new round of pills. Steps 116 and 117 may be giving and receiving inputs from a human user manually handling the packages, or steps 116 and 117 may involve the counting apparatus communicating with an automated packaging machine being used in conjunction with the counting apparatus.

1. A pill conveying apparatus comprising:
a. a housing with a pill discharge aperture formed therein;
b. a vacuum drum positioned at least partially within the housing, the vacuum drum including (i) a drum face having a primary surface; (ii) a plurality of pill apertures formed in the drum face, and (iii) at least one secondary surface formed on the drum face, the secondary surface varying in elevation relative to the primary surface;
c. a vacuum source drawing a vacuum through the pill apertures in the vacuum drum;
d. a torque source operatively connected to the vacuum drum in order to rotate the vacuum drum;
e. a pill shelf positioned adjacent to the drum face;
f. a pill removal arm inhibiting multiple pills from being retained on a pill aperture by the vacuum source; and
g. a pill sensor positioned to detect pills which will exit the discharge aperture.

2. The pill conveying apparatus according to claim 1, wherein the secondary surface is either a depression or mound.

3. The pill conveying apparatus according to claim 1, wherein the secondary surface is a depression.

4. The pill conveying apparatus according to claim 3, wherein the vacuum drum includes a perimeter area and the depression is positioned at least partially in the perimeter area.

5. The pill conveying apparatus according to claim 4, wherein the depression is positioned (i) more proximate to a first pill aperture than a second pill aperture; and (ii) rearward of the first pill aperture relative to a primary rotational direction of the vacuum drum.

6. The pill conveying apparatus according to claim 3, wherein the depression includes a leading portion and a trailing portion and the leading portion is narrower than the trailing portion.

7. The pill conveying apparatus according to claim 5, further comprising a plurality of depressions.

8. The pill conveying apparatus according to claim 3, wherein the depression is predominantly positioned in the perimeter area.

9. The pill conveying apparatus according to claim 3, wherein an upper end of the drum face is tilted at least 10° from a gravitational vertical in a direction away from the pill shelf.

10. The pill conveying apparatus according to claim 9, wherein the drum face is tilted no more than about 70° from the gravitational vertical.

11. The pill conveying apparatus according to claim 10, wherein the drum face is tilted between about 15° and about 40° from the gravitational vertical.

12. The pill conveying apparatus according to claim 3, wherein the pill removal arm is positioned such that the pill removal arm extends no further than half-way across a diameter of the pill apertures as the pill apertures pass the pill removal arm.

13. The pill conveying apparatus according to claim 12, wherein the pill removal arm is positioned no further away from the pill aperture than one-half the diameter of the pill apertures.

14. The pill conveying apparatus according to claim 1, wherein all of the pill apertures have the same diameter.

15. The pill conveying apparatus according to claim 1, wherein a center of at least one pill aperture is positioned at least one-half of a diameter of the pill aperture away from a perimeter edged of the drum face.

16. The pill conveying apparatus according to claim 15, wherein a center of at least one pill aperture is positioned at least a full diameter of the pill aperture away from a perimeter edged of the drum face.

17. The pill conveying apparatus according to claim 1, wherein the drum face of the vacuum drum comprises a plate member separable from a remainder of the vacuum drum.

18. The pill conveying apparatus according to claim 1, further comprising a plurality of plate member drum faces, wherein each plate member drum face has pill apertures of a different diameter.

19-29. (canceled)

30. A pill conveying apparatus comprising:
a. a housing with a pill discharge aperture formed therein;
b. a vacuum drum positioned at least partially within the housing, the vacuum drum including (i) a drum face having a primary surface; and (ii) a plurality of pill apertures formed in the drum face;
c. a vacuum source drawing a vacuum through the pill apertures in the vacuum drum;
d. a torque source operatively connected to the vacuum drum in order to rotate the vacuum drum;
e. a pill shelf positioned adjacent to the drum face;
f. a pill removal arm inhibiting multiple pills from being retained on a pill aperture by the vacuum source;
g. a pill sensor positioned to detect pills which will exit the discharge aperture;
h. wherein an upper end of the drum face is tilted at least 10° from a gravitational vertical in a direction away from the pill shelf.

31-34. (canceled)

35. A pill conveying apparatus comprising:
a. a housing with a pill discharge aperture formed therein;
b. a vacuum drum positioned at least partially within the housing, the vacuum drum including (i) a drum face having a primary surface; and (ii) a plurality of pill apertures formed in the drum face;
c. a vacuum source drawing a vacuum through the pill apertures in the vacuum drum;
d. a torque source operatively connected to the vacuum drum in order to rotate the vacuum drum;
e. a pill shelf positioned adjacent to the drum face;
f. a pill removal arm inhibiting multiple pills from being retained on a pill aperture by the vacuum source, the pill removal arm being positioned along an arc of vacuum drum rotation on an opposite side of the housing from the pill discharge aperture; and
g. a pill sensor positioned to detect pills which will exit the discharge aperture.

36-59. (canceled)
